(19) United States
(12) Patent Application Publication
(10) Pub. No.: US 2002/0192407 A1
(43) Pub. Date: Dec. 19, 2002

(54) Pre-moistened wipe with improved feel and softness

(75) Inventors: Stephen Worth Hendrix, Clarksville, OH (US); Scott Edward Osborne, Middletown, OH (US); Marc Fredric Richards, Corinth, KY (US); Susie Richards, Ormond Beach, FL (US); Bonnie Kay West, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/083,050

(22) Filed: Feb. 26, 2002

Related U.S. Application Data
(60) Provisional application No. 60/272,618, filed on Mar. 1, 2001.

(51) Int. Cl. F16L 1/00; B65D 1/00; B32B 1/08; B29D 22/00; B29D 23/00; B27N 1/00

(52) U.S. Cl. 428/34.3; 442/327; 428/34.1

(57) ABSTRACT

A premoistened wipe comprising:

(i) nonwoven substrate; and

(ii) lotion, the lotion comprising:

(a) a softness and feel improving agent of the formula:

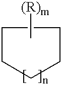

wherein each R is independently selected from the group consisting of OPO₃X₂, PO3X, SO3X, OSO₃X₂, SiO2; each X is independently selected form the group consisting of hydrogen, alkali metals, alkaline earth metals, ammonium and substituted ammonium; m is an integer from 1 to 7;and n is an integer selected from the group consisting of 1, 2 or 3, provided that when n is 1 m is not 6 or 7, and when n is 2 m is not 7;

(b) surfactant; and

(c) an aqueous carrier;

wherein the lotion is substantially free of polyacrylate homopolymers and polyacrylate copolymers, the lotion has a pH of from about 4 to about 7 and said substrate is releasably carrying said lotion.

Also provided are article comprising the wipes and containers and methods of preparing the wipes.

### CROSS REFERENCE

This is application claims priority under 35 U.S.C. §120 to Provisional Application Serial No. 60/272,618, filed Mar. 1, 2001.

### FIELD OF THE INVENTION

The present invention is related to disposable pre-moistened wipes, articles containing disposable pre-moistened wipes, and methods of preparing the disposable pre-moistened wipes.

### BACKGROUND OF THE INVENTION

There are many things desired of a premoistened wipe, both the lotion and substrate. It is desirable that compositions used in wipe products be highly homogeneous. Thus, the components should be homogeneously distributed in the lotion so as to provide consistent application of the lotion to, or distribution of the lotion in, premoistened substrates, the skin, or other surfaces. It is also desirable for the lotion to rapidly de-emulsify upon application to the skin, and to resist re-emulsification after such application. The residue left by a wipe should also have several properties. The residue should protect the skin against irritants accompanying body waste, yet should not significantly reduce transepidermal moisture loss, i.e., the skin should be allowed to breathe even in the presence of the residue (thus, the residue is non-occlusive). Occlusive barrier agents tend to cause excess hydration of the skin, which renders the skin more susceptible to irritation or infection. Moreover, it is desirable for the residue to provide easier cleansing of the perineal region. Finally, the lotion used in the disposable wipe should not negatively impact the physical properties of the nonwoven substrate so as to excessively reduce its utility for the intended application.

However, while it is desirable that the residue and the wipe provide a favorable esthetic, particularly tactile, perception to the user of the wipe (the user of the wipe may be a wearer of an incontinence article or a care-giver to such wearer) little if any, success has been achieved in this area. Typically, wipes initially proved a favorable tactile esthetic, but this quickly vanishes upon the initial use. This results in the wipe becoming greasy, oily, sticky and/or tacky in the consumers hand while they are wiping with the product. Many unsuccessful attempts have been made to reduce or eliminate this resulting tackiness. For example, using the minimum amount of lotion, using a lotion with a low coefficient of friction. However the problem remains that upon application of friction premoistened wipes loose any favorable tactile esthetic and become greasy, oily, sticky and/or tacky in the users hand.

There has thus been a need for a wipe product that does not become greasy, oily, sticky and/or tacky upon use but instead retains a favorable tactile esthetic by providing lasting softness and feel to the touch.

### SUMMARY OF THE INVENTION

In accordance with a first aspect of the present invention, a premoistened wipe is provided. The wipe comprises:

(i) nonwoven substrate; and

(ii) lotion, the lotion comprising:

(a) a softness and feel improving agent of the formula:

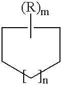

wherein each R is independently selected from the group consisting of OPO₃X₂, PO3X, SO3X, OSO₃X₂, SiO2; each X is independently selected form the group consisting of hydrogen, alkali metals, alkaline earth metals ammonium, and substituted ammonium; m is an integer from 2 to 7; and n is an integer selected from the group consisting of 1, 2 or 3, provided that when n is 1, mis not 6 or 7, and when n is 2, mis not 7;

(b) a surfactant; and

(c) an aqueous carrier;

wherein the lotion is substantially free of polyacrylate homopolymers and polyacrylate copolymers, the lotion has a pH of from about 4 to about 7 and the substrate is releasably carrying the lotion.

In accordance with a second aspect of the present invention, an article of manufacture is provided. The article of manufacture comprises:

(A) a container;

(B) a plurality of pre-moistened wipes, the pre-moistened wipes comprising the premoistened wipes according to the first aspect of the present invention.

In accordance with a third aspect of the present invention, a method of improving the softness and feel and/or reducing the tackiness of a premoistened wipe is provided. The method comprises the steps of:

(I) selecting a softness and feel improving agent of the formula:

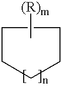

wherein R, m and n are as hereinbefore described;

(II) selecting a nonwoven substrate;

(III) selecting a surfactant;

(IV) selecting an aqueous carrier;

(V) combine the softness and feel improving agent selected in (I) with the surfactant selected in (III) and the aqueous carrier selected in (IV) to form a lotion, provided that the lotion is substantially free of polyacrylate homopolymers and polyacrylate copolymers and the lotion has a pH of from about 4 to about 7; and

(VI) wetting nonwoven substrate selected step (I) with the with a lotion prepared in step (V) such that the substrate releasably carries the lotion.

All patents, articles, documents, and other materials cited herein are hereby incorporated by reference, unless otherwise indicated.

All percentages, ratios and proportions are by weight, and all temperatures are in degrees Celsius (° C.), unless otherwise specified. All measurements are in SI units unless otherwise specified.

### DETAILED DESCRIPTION OF THE INVENTION

Definitions:

The term “aqueous solution” as used herein refers to a solution that is at least 50 percent by weight water.

The term “pre-moistened wipe” as used herein refers to a wipe which includes a substrate which is moistened, such as by wetting the substrate with a liquid composition, prior to use by the consumer. In particular, “pre-moistened wipe” refers to wipes having a substrate which is moistened prior to packaging, such as in a generally moisture impervious container or wrapper.

Such pre-moistened wipes, which can also be referred to as “wet wipes” and “towelettes”, are suitable for use in cleaning male and female babies, as well as adults of all ages. Such wipes also include articles used for application of substances to the body, including but not limited to application of make-up, skin conditioners, ointments, and medications. Such wipes can also include such articles used for cleaning or grooming of pets, and articles used for general cleansing of surfaces and objects, such as household kitchen and bathroom surfaces, eyeglasses, exercise and athletic equipment, automotive surfaces, and the like.

As used herein, the term “weight percent” or “percent by weight” is meant to refer to the quantity by weight of a component in the lotion of the wipe as a percentage of the total weight of the lotion.

As used herein, the term “water soluble” means that a component is soluble or otherwise dispersible (such as to provide a micellar solution) in water at a level of at least about 0.25 percent by weight at 25 degrees Centigrade.

As used herein, the term “surfactant” refers to materials which preferably orient toward an interface, classes of surfactants including nonionic surfactants, anionic surfactants, cationic surfactants, amphoteric surfactants, zwitterionic surfactants, and mixtures thereof.

As used herein, the terms “emulsifier” or “solubilizer” refer to a component that reduces the tendency of one or more other components in a lotion composition to phase separate from the lotion.

As used herein, the term “cosurfactant” means a component that can act as either a surfactant or an emulsifier/solubilizer.

As used herein, the term “biological surface” is meant to refer to a surface on an organism, typically an outer surface of the organism, such as skin, hair nails and the like. It also includes within its scope specific locations on an organism, such as face, hands, bottom, and the like. Also included are a variety of organisms, such as adult, minor, toddlers and baby humans, other higher primates, etc. Typical examples include babies skin which have been soiled by urine, fecal matter, food and the like, such as the face, hands, bottom, etc.

As used herein, the phrase “biological contact surface” means any surface that an organism could come into contact with. For example this may include surfaces that a child places in the mouth, place their mouth on (i.e. by gumming, chewing or licking a surface) or place something in their mouth which has been in contact with the surface (i.e. by placing a pacifier in the infant's mouth which has contacted the surface). Illustrative examples of the former include pacifiers (also known as “binkies” or “dummies”), baby bottle nipples or teats, rattles, the infant's hand, the infant's foot, articles of clothing, baby spoons, and the like. Illustrative examples of the latter include, the inside of a baby bottle, the hand or other exposed skin of a care giver, articles of clothing, a high chair-especially the tray on a high chair, or infant car seat, shopping carts, slides and the like in a park, kitchen counter tops, and the like.

As used herein, the term “comprising” means that the various components, ingredients, or steps can be conjointly employed in practicing the present invention. Accordingly, the term “comprising” encompasses the more restrictive terms “consisting essentially of” and “consisting of”.

(i) Substrate:

The pre-moistened wipe of the present invention comprises a substrate including a woven or nonwoven web of natural fibers, synthetic fibers, or mixtures of natural and synthetic fibers. Suitable natural fibers include but are not limited to cellulosic fibers, such as wood pulp fibers, cotton, and rayon. Suitable synthetic fibers include fibers commonly used in textiles, including but not limited to polyester and polypropylene fibers.

Various forming methods can be used to form a suitable fibrous web for use in the present invention. For instance, the web can be made by nonwoven dry forming techniques, such as air-laying, or alternatively by wet laying, such as on a papermaking machine. Other nonwoven manufacturing techniques, including but not limited to techniques such as adhesive bonding, melt blown, spunbonded, needle punched, and hydroentanglement and lamination methods may also be used.

In one embodiment, the dry fibrous web can be an airlaid nonwoven web comprising a combination of natural fibers, staple length synthetic fibers and a latex binder. The dry fibrous web can be about 20-80 percent by weight wood pulp fibers, 10-60 percent by weight staple length polyester fibers, and about 10-25 percent by weight binder.

The dry, fibrous web can have a basis weight of between about 40 and about 80 grams per square meter. The density of the dry web can be measured after evaporating the liquid from the premoistened wipe, and the density can be less than about 0.12 grams per cubic centimeter. The density is the basis weight of the dry web divided by the thickness of the dry web, measured in consistent units, and the thickness of the dry web is measured using a circular load foot having an area of about 2 square inches and which provides a confining pressure of about 95 grams per square inch. In one embodiment, the dry web can have a basis weight of about 64 grams per square meter, a thickness of about 0.06 cm, and a density of about 0.11 grams per cubic centimeter.

In one embodiment, the dry fibrous web can comprise at least 50 percent by weight wood pulp fibers, and more preferably at least about 70 percent by weight wood pulp fibers. One particular airlaid nonwoven web which is suitable for use in the present invention comprises about 73.5 percent by weight cellulosic fibers (Southern softwood Kraft having an average fiber length of about 2.6 mm); about 10.5 percent by weight polyester fibers having a denier of about 1.35 gram/9000 meter of fiber length and a staple length of about 0.85 inch; and about 16 percent by weight of a binder composition comprising a styrene butadiene copolymer. The binder composition can be made using a latex adhesive commercially available as Rovene 5550 (49 percent solids styrene butadiene) available from Mallard Creek Polymers of Charlotte, N.C.

One suitable airlaid nonwoven web for use in the present invention is the airlaid nonwoven web employed in PAMPERS BABY FRESH brand baby wipes marketed by The Procter & Gamble Co. of Cincinnati, Ohio.

The following patents are incorporated herein by reference for their disclosure related to webs: U.S. Pat. No. 3,862,472 issued Jan 28, 1975; U.S. Pat. No. 3,982,302 issued Sept. 28, 1976; U.S. Pat. No. 4,004,323 issued Jan. 25, 1977; U.S. Pat. No. 4,057,669 issued Nov. 8, 1977; U.S. Pat. No. 4,097,965 issued Jul. 4, 1978; U.S. Pat. No. 4,176,427 issued Dec. 4, 1979; U.S. Pat. No. 4,130,915 issued Dec. 26, 1978; U.S. Pat. No. 4,135,024 issued Jan. 16, 1979; U.S. Pat. No. 4,189,896 issued Feb. 26, 1980; U.S. Pat. No. 4,207,367 issued Jun. 10, 1980; U.S. Pat. No. 4,296,161 issued Oct. 20, 1981; U.S. Pat. No. 4,309,469 issued Jan 25, 1982; U.S. Pat. No. 4,682,942 issued Jul. 28, 1987; and U.S. Pat. Nos. 4,637,859; 5,223,096; 5,240,562; 5,556,509; and 5,580,423.

In one alternative embodiment, the substrate can comprise a hydroentangled web having a basis weight of about 62 grams per square meter and comprising about 50 percent by weight rayon fibers and about 50 percent by weight polyester fibers, polypropylene fibers, or a combination thereof. In another alternative embodiment, the substrate can comprise a laminate of two outer hydroentangled webs, such as nonwoven webs of polyester fibers having a basis weight of about 30 grams per square meter, joined to an inner constraining layer, which can be in the form of net-like scrim or a continuous plastic film material which contracts upon heating to provide surface texture in the outer layers.

The premoistened wipe is made by wetting the dry substrate with at least 0.5 grams of composition per gram of dry fibrous web. Preferably, the dry substrate is wetted with at least about 1.0 grams, and more preferably at least about 1.5 grams of composition per gram of the dry substrate. Preferably, the dry substrate is wetted with at most about 5.0 grams, more preferably at most about 4.0 grams, even more preferably at most about 3.5 grams of composition per gram of the dry substrate. A “loading factor” of 0.5 means that the dry substrate is wetted with 0.5 grams of composition per gram of dry substrate.

In one embodiment of the present invention the surface of substrate is essentially flat. In another embodiment of the present invention the surface of the substrate may optionally contain raised and/or lowered portions. These can be in the form of logos, indicia, trademarks, geometric patterns, images of the surfaces that the wipes are intended to clean (i.e. infant's bottom, adults face, etc.,). They may be randomly arranged on the surface of the substrate or be in a repetitive pattern of some form. They may be on one or both surfaces of the substrates. In one embodiment the substrate contains a repetitive pattern or alternating raised and lowered portions of the substrate. This variation in or on the surface of the substrate may be included to convey to the consumer information on the wipes intended use, which brand or type of wipe they are using is or even to aid in cleaning of the surface that the wipe is applied. In one embodiment the surface of the substrate that is in contact with the consumer is smooth, while the opposing surface that contacts the item cleaned is rough or irregular in some fashion. It is believed, while not wishing to be limited by theory, that the variations in or on the surface providing mechanical effort to the surface in addition to the wiping action.

It is also within the scope of the present invention that the term substrate includes laminates of two or more substrates. Commercially available laminates, or purpose built ones would also be within the scope of the present invention.

In one embodiment of the present invention the substrate is flushable. That is, it may be disposed of by flushing it down a toilet, commode or the like and the substrate would not block the toilet or be a problem for a septic system.

In another embodiment of the present invention the substrate is biodegradable. For example the substrate could be made from a biodegradable material such as a polyesteramide.

(ii) Lotion:

The lotion of the present invention suitable for use in a disposable wiping article and/or in a premoistned wipe comprises a softness and feel improving agent, a surfactant and aqueous carrier. It is preferred that the lotion compositions used herein are transparent or translucent, more preferably clear. However opaque or colored lotion compositions are still within the scope of the present invention.

The lotion compositions of the present invention are substantially free of polyacrylate homopolymers and/or polyacrylate copolymers. By “substantially free” it is meant that there is no polyacrylate homopolymers and/or polyacrylate copolymers added to the lotion composition and approximately about 0% by weight of lotion of polyacrylate homopolymers and/or polyacrylate copolymers is present in the lotion. Typically the lotion compositions will contain no added polyacrylate homopolymers and/or polyacrylate copolymers, more preferably the lotion compositions are totally free of polyacrylate homopolymers and/or polyacrylate copolymers.

(a) Softness and Feel Improving Agent:

The lotion compositions of the present invention comprise a softness and feel improving agent of the formula:

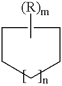

wherein each R is independently selected from the group consisting of OPO₃X₂, PO3X, SO3X, OSO₃X₂, SiO2; each X is independently selected form the group consisting of hydrogen, alkali metals, alkaline earth metals, ammonium, and substituted ammonium; m is an integer from 1 to 7;and n is an integer selected from the group consisting of 1, 2 or 3, provided that when n is 1, m is not 6 or 7, and when n is 2, m is not 7.

In one embodiment of the present invention n =1 and the softness and feel improving agent has the formula:

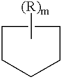

wherein R and m are as hereinbefore described.

In one embodiment of the present invention n=2 and the softness and feel improving agent has the formula:

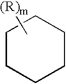

wherein R and m are as hereinbefore described.

In one embodiment of the present invention n 3 and the softness and feel improving agent has the formula:

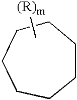

wherein R and m are as hereinbefore described.

In one preferred embodiment of the present invention each R is independently selected from the group consisting of OPO₃X₂, PO3X, OSO₃X₂, SiO2.

In one preferred embodiment of the present invention m is an integer from 3 to 7, more preferably 4 to 7.

In one preferred embodiment of the present invention each X is independently selected form the group consisting of hydrogen, sodium, potassium, magnesium, calcium, ammonium, substituted ammonium.

In another preferred embodiment of the present invention the softness and feel improving agent is myo-inositol hexakispohosphoric acid and salts thereof. That is m=6, n=2 and each R, is OPO₃X₂. Myo-inositol hexakispohosphoric acid is also commonly known as phytic acid.

In the present compositions, the softness and feel improving agent is typically present at levels from about 0.0002% to about 2%, preferably from about 0.001% to about 0.7%, and more preferably from about 0.002% to about 0.4%, by weight of the composition.

(b) Surfactant

The lotion composition of the present invention preferably includes a surfactant. Specifically, the composition preferably includes a surfactant selected from the group consisting of nonionic surfactants, anionic surfactants, cationic, amphoteric, zwitterionic and mixtures thereof. Illustrative examples of suitable are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

Surfactant, when present, is typically employed in compositions at levels of from about 0.001% to about 5%, preferably from about 0.002% to about 2%, and more preferably from about 0.003% to about 1%, by weight of the composition.

Nonionic surfactants—when used, any suitable nonionic surfactant may be utilized. For example, branched, mid-chain branched, linear, capped, uncapped, low foaming, etc. Some suitable nonionic surfactants include alkylene oxide (ethylene oxide and/or propylene oxide) adducts of aliphatic alcohols, phenols or acids, ethylene oxide, propylene oxide block copolymer, polysorbates, aliphatic alcohol adducts of glucose (alkyl polyglucosides or APG). Mixtures of nonionic surfactants are also possible.

Specific examples of suitable nonionic surfactants include Isoceteth-20, an alkoxylated alcohol, commercially available as Arlasolve 200 from Uniqema, Concord Plaza, Wilmington, Del.; Pluronic 62 brand, a block copolymer of propylene oxide and ethylene oxide available from BASF Corporation, Mount Olive, NJ; Poloxamer 101-Poloxamer 407 block copolymers of propylene oxide and ethylene oxide; the Dobanol™ and Neodol® series of nonionic surfactants available from Shell Oil Company; the Synperonic series of nonionic surfactants available from Imperial Chemical Industries PLC; the Lutensol® series of nonionic surfactants commercially available from BASF; the Tergitol® series of nonionic surfactants are commercially available from UNION CARBIDE.

Another class of suitable of nonionic surfactants are the polyalkylene oxide polysiloxanes. Typically the polyalkylene oxide polysiloxanes have a dimethyl polysiloxane hydrophobic moiety and one or more hydrophilic polyalkylene chains. The hydrophilic polyakylene chains can be incorporated as side chains (pendant moieties) or as block copolymer moieties with the polysiloxane hydrophobic moiety. Polyalkylene oxide polysiloxanes are described by the following general formulas:

R₁—(CH₃)₂SiO—[(CH₃)₂SiO]ₐ—[(CH₃)(R₁)SiO]_{b}—Si(CH₃)₂—R₁

wherein a+b are from about 1 to about 50, preferably from about 1 to about 30, more preferably from about 1 to about 25, and each R₁ is the same or different and is selected from the group consisting of methyl and a poly(ethyleneoxide/propyleneoxide) copolymer group having the general formula:

—(CH₂)ₙ O(C₂H₄ O)_{c}(C₃H6 O)_{d} R₂

with at least one R₁ being a poly(ethyleneoxy/propyleneoxy) copolymer group, and wherein n is 3 or 4, preferably 3; total c (for all polyalkyleneoxy side groups) has a value of from 1 to about 100, preferably from about 6 to about 100; total c+d has a value of from about 5 to about 150, preferably from about 7 to about 100 and each R₂ is the same or different and is selected from the group consisting of hydrogen, an alkyl having 1 to 4 carbon atoms, and an acetyl group, preferably hydrogen and/or methyl group. Each polyalkylene oxide polysiloxane has at least one R₁ group being a poly(ethyleneoxide/propyleneoxide) copolymer group.

Nonlimiting examples of these type of surfactants are the Silwet® surfactants which are available from CK-Witco. Representative Silwet® surfactants which contain only ethyleneoxy (C₂H₄ O) groups are Silwet L-7608; Silwet L-7607; Silwet L-77; Silwet L-7605; Silwet L-7604; Silwet L-7600; Silwet L-7657; Silwet L-7602; Silwet L-7622; Silwet L-8600; Silwet L-8610; and Silwet L-8620.

Nonlimiting examples of Silwet® surfactants which contain both ethyleneoxy (C₂H₄ O) and propyleneoxy (C₃H₆ O) groups are Silwet L-720; Silwet L-7001; Silwet L-7002; Silwet L-7210; Silwet L-7200; and Silwet L-7220.

Nonlimiting examples of Silwet® surfactants which contain only propyleneoxy (C₃H₆ O) groups are Silwet L7500; Silwet L7510; Silwet L7550; and Silwet L8500.

The number of ethyleneoxy units (—C₂H₄ O) in the polyether chain (R₁) must be sufficient to render the polyalkylene oxide polysiloxane water dispersible or water soluble. If propyleneoxy groups are present in the polyalkylenoxy chain, they can be distributed randomly in the chain or exist as blocks. Nonlimiting examples of preferred Silwets® include L7001, L7200, and L7087. Mixtures of Silwet® surfactants with preferred properties are also within the scope of the present invention.

If used in the present compositions, nonionic surfactant is typically present at levels from about 0.0002% to about 2%, preferably from about 0.001% to about 0.7%, and more preferably from about 0.002% to about 0.4%, by weight of the composition.

Anionic surfactants—Anionic surfactants can be employed, in the lotion compositions of the present invention. Some suitable anionic surfactants include, but are not limited to: alkylbenzene sulfonate (including linear, high 2-phenyl, MLAS variations); branched or linear, substituted or unsubstituted alkyl sulfonate, branched or linear, substituted or unsubstituted alkyl sulfate; alkyl ether sulfates; alkoxylated sulphate, such as the alkyl ethoxylated sulphates; isethionates; alkyl phenol ethylene oxide ether sulfates, paraffin sulfonates; alkyl phosphates, such as the acyl isethionates; N-acyl taurates, alkyl succinamates and sulfosuccinates; monoesters of sulfosuccinate; alkyl-carboxylates; alkyl polyethoxy carboxylate; phosphate esters of ethylene and/or ethylene/propylene oxide adducts of aliphatic alcohols; dialkyl sulfosuccinates; 2-ethylhexyl sulfate; and mono and di-methyl naphthalene sulfonates.

Amphoteric surfactants—Suitable amphoteric surfactants to be used herein include amine oxides having the following formula R¹R²R³NO wherein each of R¹, R² and R³ is independently a saturated substituted or unsubstituted, linear or branched hydrocarbon chains of from 1 to 30 carbon atoms. Preferred amine oxide surfactants to be used according to the present invention are amine oxides having the following formula R¹R²R³NO wherein R¹ is an hydrocarbon chain comprising from 1 to 30 carbon atoms, preferably from 6 to 20, more preferably from 8 to 16, most preferably from 8 to 12, and wherein R² and R³ are independently substituted or unsubstituted, linear or branched hydrocarbon chains comprising from 1 to 4 carbon atoms, preferably from 1 to 3 carbon atoms, and more preferably are methyl groups. R¹ may be a saturated substituted or unsubstituted, linear or branched hydrocarbon chain.

Suitable amine oxides for use herein are for instance natural blend C₈-C₁ amine oxides as well as C₁₂-C₁₆ amine oxides commercially available from Hoechst.

Zwitterionic Surfactants—Suitable zwitterionic surfactants which may be used herein contain both cationic and anionic hydrophilic groups on the same molecule at a relatively wide range of pH's. The typical cationic group is a quaternary ammonium group, although other positively charged groups like phosphonium, imidazolium and sulfonium groups can be used. The typical anionic hydrophilic groups are carboxylates and sulfonates, although other groups like sulfates, phosphonates, and the like can be used.

Highly preferred zwitterionic surfactants include betaine and sulphobetaine surfactants, derivatives thereof or mixtures thereof. Furthermore, due to the mild action profile of the betaine or sulphobetaine surfactants, they are particularly suitable for the cleaning of delicate surfaces, e.g., babies skin. Betaine and sulphobetaine surfactants are also extremely mild to the skin and/or surfaces to be treated.

Suitable betaine and sulphobetaine surfactants include functionalized betaines such as acyl betaines, alkyl imidazoline alanine betaines, glycine betaines, derivatives thereof. Some common examples of these detergents are described in U.S. Pat. Nos. 2,082,275, 2,702,279 and 2,255,082, incorporated herein by reference.

Examples of particularly suitable betaine surfactants include alkyl dimethyl betaine such as coconut-betaine and laurylbetaine. Coconutbetaine is commercially available from Seppic under the trade name of Amonyl 265®. Laurylbetaine is commercially available from Albright & Wilson under the trade name Empigen BB/L®. Another series of suitable betaine and sultaines surfactants are the Mackam series of surfactants available from McIntyre Group, Chicago Ill. USA. Suitable examples include Mackam LMB®, which is Lauramidopropyl betaine, Mackam CBS50G® which is cocamidopropyl hydroxysultaine.

Other suitable zwitterionic surfactants include C₁₀-C₁₄ fatty acylamidopropylene(hydroxypropylene)sulfobetaine that is available from the Sherex Company under the trade name “Varion CAS sulfobetaine”®.

Zwiterionic surfactant, when present, is typically employed in compositions at levels of from about 0.001% to about 5%, preferably from about 0.002% to about 2%, and more preferably from about 0.003% to about 1%, by weight of the composition.

(c) Aqueous Carrier

The major proportion, e.g., more than about two thirds, (typically, approximately 80%-99.7%, by weight) of the compositions herein comprises water as the solubilizing carrier for the ingredients and optionally a toxicologically-acceptable organic solvent. Suitable toxicologically-acceptable organic solvent include, but are not limited to, C₁-C₆ alcohols, C₂-C₆ diols, C₃-C₆ triols, and mixtures thereof. One example of a suitable aqueous carrier is water. Another example of a suitable aqueous carrier is water and dipropylene glycol. A further example of a suitable aqueous carrier is water and ethanol. The level of toxicologically-acceptable organic solvent in the composition preferably should not exceed 10% in the composition to avoid a solvent odor. However, higher levels may be used in situations where the solvent odor is not an issue. Another preferred toxicologically-acceptable organic solvent is glycerol.

Mixtures of toxicologically-acceptable organic solvents are within the scope of the present invention.

The optional organic solvent, when used, is typically present in the compositions at levels from about 0.001% to about 5%, preferably from about 0.002% to about 2%, and more preferably from about 0.003% to about 1%, by weight of the composition.

Composition pH

The pH of the lotion composition of the present invention can vary. The composition has a pH from about 2 to about 9.5; or even have a “neutral” pH, i.e. have a pH from about 6 to about 9.5. The choice of pH depends upon the many factors. These include, but are not limited to, substrate choice, components of the composition, item to be cleaned, etc.

In any event whichever pH range is selected it is preferred that all components of the premoistened wipe, be stable in that pH range. That means that all the components present in the composition, and the substrate are stable in that pH range.

Optional Ingredients

The lotion of the present invention may include additional optional ingredients. Some illustrative additional lotion ingredients can be found in U.S. Pat. No. 5,534,265 issued Jul. 9, 1996; U.S. Pat. No. 5,043,155 issued Aug. 27, 1991; and U.S. Pat. No. 5,648,083 issued Jul. 15, 1997 all of which are incorporated herein by reference.

Optional ingredients, when used, are each typically present in the compositions at levels from about 0.001% to about 5%, preferably from about 0.002% to about 2%, and more preferably from about 0.003% to about 1%, by weight of the composition.

Polymers—In one embodiment, the lotion preferably contains non-cellulosic water soluble organic polymers comprising polymers of ethylene oxide. A preferred polymer is PEG-7M, an ethylene oxide with the formula H(OCH₂CH₂)ₙOH, and n=150 to 160000. A suitable PEG-7M is commercially available as Polyox WSR N-750 from Union Carbide Corporation, Danbury, Conn. 06817-0001.

Preservative—Formulating the present compositions at high pH reduces the tendency for biological growth of contaminants, such as bacteria, fungi, or molds. Similarly, in compositions with acidic or neutral pH biological growth of contaminants, such as bacteria, fungi, or molds may also be an issue. However, preservatives can help insure the lack of biological growth through contamination in making or in use. For example, including a preservative to inhibit and/or eliminate moulds. May not be necessary in compositions with a basic pH. However, it is still possible to include preservatives in compositions with a basic pH.

Preservatives prevent the growth of micro-organisms in the liquid lotion and/or the substrate. Generally, such preservatives are hydrophobic or hydrophilic organic molecules. Suitable preservatives include, but are not limited to parabens, such as methyl parabens, propyl parabens; organic acids such as malic acid, and benzoic acid; and combinations thereof. Another suitable preservative is hudroxymethylglycinate which is commercially available from Syutton Laboratories under the trade name SUTTOCIDE A.

Preservatives, when used, are typically present in the compositions at levels from about 0.001% to about 5%, preferably from about 0.002% to about 2%, and more preferably from about 0.003% to about 1%, by weight of the composition.

Humectant—Humectants are hygroscopic materials that function to draw water into the stratum corneum to hydrate the skin. The water may come from the dermis or from the atmosphere. Examples of humectants include glycerin, propylene glycol, and phospholipids.

Emollient—As used herein, an emollient is a material that softens, soothes, supples, coats, lubricates, or moisturizes the skin. The term emollient includes, but is not limited to, conventional lipid materials (e.g. fats, waxes), polar lipids (lipids that have been hydrophylically modified to render them more water soluble), silicones, hydrocarbons, and other solvent materials. Emollients useful in the present invention can be petroleum based, fatty acid ester type, alkyl ethoxylate type, fatty acid ester ethoxylates, fatty alcohol type, polysiloxane type, mucopolysaccharides, or mixtures thereof. Some Examples of suitable emollients include, lanolin, petrolatum cod liver oil and mineral oil.

Exemplary silicone oils that are suitable for used herein include dimethicone (alternatively referred to as linear polydimethylsiloxane polymer, dimethyl silicone), substituted linear dimethicones, cyclomethicone, dime-thiconol, trimethylsiloxysilicate, and mixtures thereof. Such silicones are commercially available, for example, from the Dow Corning Company of Midland, Mich. under the trade names Dow Corning 200 fluid (dimethicone), Dow Corning 1401 fluid (cyclomethicone and dimethiconol), Dow Corning 593 fluid (dimethicone and trimethylsiloxysilicate), and Dow Corning 2503 fluid (stearyl dimethicone). These and other silicone oils that may be suitable for use herein are described in the technical brochure numbered 24-414C-93 and entitled “Shaping Solutions for Personal Care,” Dow Corning Corporation, Midland, Mich. 1993. Another suitable emollient is Dermol G-7LC® (polyethylene (7) glyceryl Ether lactate or Glycereth-7-lactate) which is available from Alzo international, NJ USA. Dermol G-7LC ® is a naturally derived emollient made from lactic acid.

Perfume—Perfumes are optionally incorporated in the present compositions to impart an aesthetically satisfying odor to the composition. A variety of perfume materials can be utilized, especially those imparting odor characters such as citrus, pine, and “outdoor” fresh. Alternatively, a perfume may be incorporated in order to mask any objectionable ingredient odor. Some of the perfumes useful herein are described in more detail in U.S. Pat. No. 5,108,660, Michael, issued Apr. 28, 1992, at col. 8 lines 48 to 68, and col. 9 lines 1 to 68, and col. 10 lines 1 to 24, said patent, and especially said specific portion, being incorporated by reference.

Perfume solubilizer—Perfume solubilizers are components which reduce the tendency of the water insoluble perfume component to precipitate from the lotion. Examples of perfume solubilizers include alcohols such as ethanol, isopropanol, benzyl alcohol, and phenoxyethanol; any high HLB (HLB greater than 13) emulsifier, including but not limited to polysorbate; and highly ethoxylated acids and alcohols.

Chelant—The preferred chelant herein are polyphosphate salts or organic polycarboxylic salts, e.g., sodium and/or potassium citrate, and/or sodium and/or potassium ethylenediaminetetraacetate, which are standard items of commerce. Other organic polycarboxylic acids, such as citric, tartaric, malic, etc. acids, can also be used. Complex phosphates can also be used, but are generally avoided due to regulatory considerations where phosphate levels are specifically forbidden or highly restricted. Typically, if used, the chelant is present at a level of from about 0.0005% to about 3%, preferably from about 0.001% to about 0.5%, and more preferably from about 0.003% to about 0.2%, by weight of the composition. Chelant can maintain the efficacy of the formulas in the presence of hardness.

Buffer—Buffers may be used in the lotions herein to maintain product pH in the desired range. For ease of formulatability, it is often desirable that such buffers be in their potassium salt form. Sodium salts are acceptable, and even preferred, in conjunction with alkyl sulfate/sulfonate surfactants. Potassium and/or sodium carbonate, potassium and/or sodium bicarbonate, potassium and/or sodium hydroxide (hydrate), potassium and/or sodium citrate and/or potassium and/or sodium ortho-phosphate are convenient and preferred pH buffers. Calcium and/or magnesium hydroxides can also be used to create a basic pH, especially if the composition does not contain calcium ion sequestrant. Sodium and potassium hydroxides can be used as part of buffer systems.

In the compositions, the level of buffer, when present, is typically from about 0.0005% to about 10%, preferably from about 0.0015% to about 5%, and more preferably from about 0.0025% to about 1.5%, by weight of the composition.

Skin care agent—The lotion can also comprise an effective amount of a skin care agent such as a kerotolytic, for providing the function of encouraging healing of the skin. An especially preferred kerotolytic is Allantoin ((2,5-Dioxo-4-Imidazolidinyl)Urea), a heterocyclic organic compound having an empirical formula C₄H₆N₄O₃ Allantoin is commercially available from Tri-K Industries of Emerson, N.J. A premoistened wipe according to the present invention may optionally include an effective amount of allantoin for encouraging the healing of skin, such as skin which is over hydrated. Another suitable skin care agent is Sensiva SC50®, which is available from Phonex Chemicals, NJ, USA. Sensiva SC50® contains 3[(2-ethylhexyl)oxy]1,2-propanediol.

Other Optional Ingredients—The lotions of the present invention may also optionally include other optional agents such as: skin soothing aids such as panthenol, bisabolol, ichthammol, stearyl glycyrrhetinate, ammonium glycyrrhetinate, Vitamin E (tocopherol or tocopherol acetate), Vitamin A (Retinyl or Retinyl Palmitate); plant extracts, such as, green tea extract, kola extract, oat extract, teat tree extract and aloe; and skin moisteners; powders and the like.

(C) Article of Manufacture

The present article of manufacture encompasses premoistened wipe products as described hereinbefore that can be packaged in a container with a set of instructions for the consumer. The article of manufacture of the present invention typically comprises (A) a container, (B) one or more premoistened wipes, and optionally (C) a set of instructions in association with the article comprising an instruction to wipe a surface with the premoistened wipe, wherein the surface is selected from the group consisting of biological surfaces and biological contact surfaces.

Containers useful in the present article include but are not limited, for example, PET tubs, flow wrap pouches, precut sachets for individually packed wipe, and other packaging known in the art for premoistened wipe products. Typically, premoistened of the present invention are stored in the containers to reduce evaporation of the compositions loaded onto the premoistened wipe. The container can also facilitate individual wipe removal.

In one embodiment of the present invention the article of manufacture of may be a “reach in” container, the premoistened wipes are in a folded, stacked arrangement of discreet sheets. This configuration permits one towel at a time to be exposed to the user, who “reaches in” and extracts the topmost wipe from the container. The remaining wipes remain in their stacked, folded configuration. Reach in containers often have a tub-like configuration (a rigid container) or a soft, generally rectangular package configuration and usually have a recloseable lid or cover to protect the remaining wipes from prematurely drying out.

In one embodiment of the present invention the article of manufacture of may be a “pop up” dispenser, wherein the trailing edge of a wipe being extracted from the package first draws the leading edge of the next wipe through an aperture or opening. As the first wipe exits the container, it is separated from the leading edge of the next wipe, leaving the leading edge of the next wipe held in a readily accessible position by the edges of the aperture. In one pop-up arrangement, discreet, folded wipes are interleaved in the stacked configuration. The wipes are interleaved (interfolded) such that they have overlapping edge portions which adhere to one another. The adhesion forces in the overlapping region supply the necessary force to permit one wipe to pull the leading edge of the next wipe through the container opening before separation of the respective overlapping regions occurs. The lotion systems of the present invention are particularly suitable for use in “pop-up” dispensers as they can minimize the negatives associated with “pop-up” dispensers, such as chaining, liftoff and fall back.

One such illustrative “pop-up” dispensing system for reliable single dispensing of discreet premoistened wipes in consecutive order, is the system comprising:

(A) a container having an interior portion and an aperture, preferably substantially S-shaped, which is for drawing through the premoistened wet wipes in consecutive order;

(B) a plurality of the premoistened wipes according to the first embodiment of the invention, the premoistened wipes being stacked, folded and interleaved and interleaved in the interior portion of the container, preferably the fold pattern is substantially an interfolded Z-fold;

Additional information on suitable “pop-up” dispensing system for reliable single dispensing of discreet pre-moistened wipes in consecutive order can be found in U.S. patent application Ser. No. 09/344,695 filed Jun. 25, 1999, (P&G Docket No. 7496R) relevant portions of which are incorporated herein by reference.

In one embodiment of the present invention the article of manufacture of the present invention may further comprises a set of instructions in association with the container. As used herein, the phrase “in association with” means the instructions are either directly printed on the container itself or presented in a different manner including, but not limited to, a brochure, print advertisement, electronic advertisement, and/or verbal communication, so as to communicate the set of instructions to a consumer of the article of manufacture.

The set of instructions may comprise, for example, the instruction to wipe the surface with the surface with the premoistened wipe either with or without rinsing. The instructions may include directions to use one wipe only or instructions to use multiple wipes, say two, or three or possibly even more.

The set of instructions can comprise instruction(s) to carry out the methods described hereinafter. The set of instructions is typically in association with the container of the present article.

Methods

In preparing the premoistened wipes of the present invention the composition should be placed on and/or in the substrate. Techniques for combining the wipe substrates with the composition of the present invention are well known in the art. Examples of common methods of combining the composition to the wipe substrate may involve coating, immersing, dipping, or spraying, the wipe substrate with the composition of the present invention. The composition of the present invention is added to the wipe substrate at level sufficient to provide the desired benefits of the present invention.

The present invention also includes methods improving the softness and feel and/or reducing the tackiness of a premoistened wipe. This is achieved by adding to the lotion a softness and feel improving agent, as hereinbefore described. The lotion is then added to the substrate, by any of the above illustrated methods or any other conventionally used, to produce a premoistened wipe with improved softness and feel.

The lotion of the present invention can be made according to the Examples which follow, which Examples are meant to be exemplary and not limiting.

### EXAMPLES

### Example 1

| | |
|---|---|
| | Wt % |
| Ingredients | A |

| | |
|---|---|
| Preservative¹ | 0.390 |
| Nonionic Surfactant² | 0.05 |
| Humectant³ | 1.5 |
| softness and feel | 0.2 |
| improving agent⁴ | |
| Zwitterionic Surfactant⁵ | 0.5 |
| Skin care additive⁶ | 0.1 |
| Emollient⁷ | 0.1 |
| perfume | 0.038 |
| Water and minors | q.s. to |
| | 100% |
| Buffer to pH 5.5 | |

Notes:
¹Mixture of Suttocide A and sodium benzoate;
²Silwet L-7657;
³propylene glycol’
⁴phytic acid;
⁵Mixture of Mackam LMB and Mackam CBS50C;
⁶Sensiva SC50;
⁷Dermol G-7LC.

### Example 2

| | Wt % |
|---|---|
| Ingredients | A |
| Preservative¹ | 0.15 |
| Preservative² | 0.24 |
| Nonionic Surfactant³ | 0.05 |
| Humectant⁴ | 1.5 |
| softness and feel | 0.2 |
| improving agent⁵ | |
| Zwitterionic Surfactant⁶ | 0.3 |
| Zwitterionic Surfactant⁷ | 0.2 |
| Skin care additive⁸ | 0.1 |
| Emollient⁹ | 0.1 |
| perfume | 0.038 |
| Water and minors | q.s. to |
| | 100% |
| Buffer to pH 5.5 | |

Notes:
¹Suttocide A;
²Sodium benzoate;
³Silwet L-7657;
⁴propylene glycol’
⁵phytic acid;
⁶Mackam LMB;
⁷Mackam CBS50C;
⁸Sensiva SC50;
⁹Dermol G-7LC.

### Example 3

| | % Active by wt | | |
|---|---|---|---|
| Ingredient | A | B | C |
| Propylene Glycol | 0.5 to 5 | 1.5 | 1.5 |
| Cetyl Hydroxyethylcellulose | 0.01 to 0.1 | 0.1 | |
| | 1.5% | | |
| | (0.1) | | |
| Sodium Coco PG Dimonium | 0 to 3% | 0.8 | 0 |
| Chloride Phosphate | | | |
| Perfume | 0.01 to 1.5 | 0.0375 | 0.0375 |
| Methyl Paraben | 0.02 to 3 | 0.2 | 0.2 |
| PropylParaben | 0.0 to 1.5 | 0.03 | 0.03 |
| 2-Bromo-2-Nitropropane-1,3-Diol | 0.01 to 1.5 | 0.05 | 0.05 |
| (Bronopol) | | | |
| Aloe Vera Gel-Aloe, Premium, and | 0 to 5 | 0.5 | 0 |
| Rash Care | | | |
| prefume | 0.05 | — | 0.05 |
| Phytic acid | 0.001 to 5 | 0.1 | 1.0 |
| Allantoin-Rash Care only | 0.82% | 0.82 | 0 |

| | |
|---|---|
| Water, and minors | q.s. to 100% |

### Example 4

Range/concentration (wt %)

| Ingredient | A | B |
|---|---|---|
| Propylene Glycol | 0.5 to 5 | 1.5 |
| PEG-75 Lanolin | 0.1 to 3 | 0.5 |
| Disodium Cocamphodiacetate | 0.1 to 3 | 0.5 |
| Perfume | 0.01 to 1.5 | 0.0375 |
| Polysorbate 20 | 0.02 to 3 | 0.2 |
| Methyl Paraben | 0.02 to 3 | 0.2 |
| Propyl Paraben | 0.01 to 1.5 | 0.03 |
| 2-Bromo-2-Nitropropane-1,3-Diol | 0.01 to 1.5 | 0.05 |
| Aloe Vera Gel | 0.0001 to 50 | 0.5 |
| Pentadecalactone | 0.1 to 1.5 | 0.05 |
| Phytic acid | 0.001 to 5 | 0.3 |
| Allantoin | 0.5 to 2 | 0.82 |
| Water, and minors | q.s. to 100% | |

Accordingly, while particular embodiments of the present invention have been illustrated and described, it would be obvious to those skilled in the art that various other changes and modifications can be made without departing from the spirit and scope of the invention. It is therefore intended to cover in the appended claims all such changes and modifications, including combinations of features disclosed, that are within the scope of this invention.

What is claimed is:

1 A premoistened wipe comprising:
(i) nonwoven substrate; and
(ii) lotion, said lotion comprising:
(a) a softness and feel improving agent of the formula: 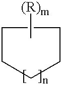
wherein each R is independently selected from the group consisting of OPO₃X₂, PO3X, SO3X, OSO₃X₂, SiO2; each X is independently selected form the group consisting of hydrogen, alkali metals, alkaline earth metals, ammonium and substituted ammonium; m is an integer from 1 to 7;and n is an integer selected from the group consisting of 1, 2 or 3, provided that when n is 1 m is not 6 or 7, and when n is 2 m is not 7;
(b) surfactant; and
(c) an aqueous carrier;
wherein said lotion is substantially free of polyacrylate homopolymers and polyacrylate copolymers, said lotion has a pH of from about 4 to about 7 and said substrate is releasably carrying said lotion.

2. The premoistened wipe of claim 1, wherein each X is independently selected from the group consisting of sodium, potassium, magnesium, and calcium.

3. The premoistened wipe of claim 2, wherein said softness and feel improving agent comprises from about 0.001% to about 5% percent by weight of the lotion.

4. The premoistened wipe of claim 1, wherein said surfactant is selected from the group consisting of anionic surfactants, nonionic surfactants cationic surfactants, amphoteric surfactants, zwitterionic surfactants and mixtures thereof.

5. The premoistened wipe of claim 4, wherein said nonionic surfactant is selected from the group consisting of alkoxylated alcohols, alkyl phenols, polyhydroxy fatty acid amides, alkyl polyglycosides, C₁₀-C₁₈ glycerol ethers, alkyl capped nonionic surfactants, condensation products of ethylene oxide and combinations thereof.

6. The premoistened wipe of claim 1, wherein said zwitterionic surfactant is selected from the group consisting of betaines, sulfobetaines and combinations thereof.

7. The premoistened wipe of claim 1, wherein said aqueous carrier is selected from the group consisting of water, C1-C3 alcohols, C2-C6 polyols, and mixtures thereof.

8. The premoistened wipe of claim 7, wherein said aqueous carrier comprises water and poropylene glycol.

9. The premoistened wipe of claim 1 further comprising an effective amount of a preservative.

10 The premoistened wipe of claim 1 wherein said substrate is wetted with at least about 1.0 gram of lotion per gram of dry substrate weight.

11. The premoistened wipe of claim 1 wherein m is 6, n is 2 and each R, is OPO3X2.

12. A method of cleaning a surface comprising contacting said surface with the premoistened wipe of claim 1.

13. An article of manufacture comprising
(A) a container; and
(B) a plurality of said pre-moistened wipes of claim 1.

14. The article of claim 13, wherein said pre-moistened wipes comprise a nonwoven substrate.

15. The article of claim 13, wherein said article further comprises:
(C) set of instructions comprising an instruction to wipe a surface with said premoistened wipe, wherein said surface is selected from the group consisting of biological surfaces and biological contact surfaces.

16. A method of improving the softness and feel and/or reducing the tackiness of a premoistened wipe comprising the steps of:
(I) selecting a softness and feel improving agent of the formula: 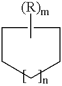
wherein each R is independently selected from the group consisting of OPO₃X₂, PO3X, SO3X, OSO₃X₂, SiO2; each X is independently selected form the group consisting of hydrogen, alkali metals, alkaline earth metals, ammonium and substituted ammonium; m is an integer from 1 to 7;and n is an integer selected from the group consisting of 1, 2 or 3, provided that when n is 1 m is not 6 or 7, and when n is 2 m is not 7;
(II) selecting a nonwoven substrate;
(III) selecting a surfactant;
(IV) selecting an aqueous carrier;
(V) combine said softness and feel improving agent selected in (I) with said surfactant selected in (III) and said aqueous carrier selected in (IV) to form a lotion, provided that said lotion is substantially free of polyacrylate homopolymers and polyacrylate copolymers and said lotion has a pH of from about 4 to about 7;and
(VI) wetting nonwoven substrate selected step (I) with said with a lotion prepared in step (V) such that said substrate releasably carries said lotion.

17. A premoistened wipe with improved softness and feel prepared according to the method of claim 16.

18. A pop-up dispensing system for reliable single dispensing of discreet premoistened wipes in consecutive order, said system comprising:
(A) a container having an interior portion and an aperture, which is for drawing through said premoistened wipes in consecutive order; and
(B) a plurality of said premoistened wipes according to claim 1, wherein said premoistened wipes being stacked, folded and interleaved and interleaved in said interior portion of said container.

19. A pop-up dispensing system according to claim 18 wherein said aperture is substantially S-shaped.

20. A pop-up dispensing system according to claim 18 wherein the fold pattern is substantially an interfolded Z-fold.
